(19) United States
(12) Patent Application Publication
(10) Pub. No.: US 2007/0197085 A1
(43) Pub. Date: Aug. 23, 2007

(54) Batteru connector and battery for protecting circuit system

(75) Inventor: Ying Chieh Li, Taipei Hsien (TW)

Correspondence Address: BRUCE H. TROXELL, SUITE 1404, 5205 LEESBURG PIKE, FALLS CHURCH, VA, 22041, US

(73) Assignee: WISTRON CORP.

(21) Appl. No.: 11/455,867

(22) Filed: Jun. 20, 2006

(30) Foreign Application Priority Data
Feb. 23, 2006 (TW) 095106026

(51) Int. Cl. H01R 3/00

(52) U.S. Cl. 439/500

(57) ABSTRACT

A battery connecter and battery for protecting a circuit system allow terminals at the outermost sides of corresponding terminals of the connecter and the battery all to be ground terminals with contact portion having a longer projection and both power terminals are all at the center so as to ensure the ground terminals of both battery and connecter to be got in touch with each other first. Whereby, the circuit system is allowed to be safer, rather not to work abnormally or electronic components thereof are not damaged when the system is connected with the battery.

### FIELD OF THE INVENTION

The present invention relates to a battery connector and battery of an electronic device, and more particularly to a battery connector and battery for protecting a circuit system.

### DESCRIPTION OF RELATED ART

Please refer to FIGS. 1 and 2. An electronic device such as a cellular phone 10 shown in FIG. 1 is provided with a combination groove 12 for receiving a battery 11; the battery 11 has a plurality of electrical connection terminals 111; the combination groove 12 is combined with a battery connector. The battery connector has a plurality of elastic electric connection terminals 13 corresponding to the electric connection terminals 111 of the battery 11. One end of each terminal 13 is extended from each one of a plurality of groove holes 122 on a bottom wall 121 of the combination groove 12. When the battery 11 is accepted in the combination groove 12, the terminals 13 in the battery connector are respectively elastically touched with the terminals 111 of the battery 11 so as to attain to an electrical connection function. The terminals 13 are a power terminal (BT+), Twp signal terminals (SCL, SDA) and a ground terminal (GND) corresponding to ones of the terminal 111 as FIG. 2 shows.

When the battery 11 is inserted into the combination groove 12, two corresponding ground terminals (GND) of the battery 11 and the battery connector must be allowed to contact with each other first, electronic components on the electronic device can then work normally. If two corresponding power terminals (BT+) are allowed to contact with each other first, the electronic device is caused to work abnormally, and the electronic components on the electronic device are even caused to damage.

Taiwan Patent Pub. No. 347,932 discloses a face contact connector; it is provided with a plurality of terminals used for contacting a connection face of a connection object and being electrically connected with the connection object, in Which the connection object mentioned above is a battery set, and the terminals mentioned above are constituted by a power terminal, ground terminals and signal terminals. But, the projection amount of the contact portions of the ground terminal is biggest, the projection amount of the power terminal is second to the biggest and the projection amount of the contact portions of the signals is smallest.

Although the ground terminals of the connector according to the present invention can first contact with ground terminals of the battery under a normal condition, because the design of a battery connector in each electronic device is not exactly similar, and difference on mechanism will cause the insertion angle of the battery to be different, for example, when the battery is inclined an angle to cause the power terminals (BT+) of the battery and the battery connector to have a shorter distance such that they will contact each other first before two ground terminals (GND) contact each other, it still can cause the electronic device to work abnormally, and even to cause the electronic components of the electronic device to be damaged.

### DESCRIPTION OF PRESENT INVENTION

For improving the design that the design of the battery connector and the battery of the conventional circuit cannot ensure the ground terminals of the both from contacting each other first, the present invention is proposed.

The main object of the present invention is to provide a battery connecter and battery for protecting a circuit system, capable of ensuring that ground terminals of the battery connecter and the battery contacting each other first.

Another object of the present invention is to provide a battery connecter and battery for protecting a circuit system, allowing the circuit system to be safer and rather not to work abnormally or electronic components thereof not to be damaged when it is electrically connected with the battery.

### BRIEF DESCRIPTION OF THE DRAWINGS

The present invention can be more fully understood by reference to the following description and accompanying drawings, in which:

FIG. 1 is a schematic view, showing a conventional battery connecter of a cellular phone and battery;

FIG. 2 is a schematic view, showing an electric connection between terminals of a conventional battery connecter and terminals of a conventional battery;

FIG. 3 is a schematic view of a battery connecter and battery of a preferred embodiment of the present invention;

FIG. 4 is a schematic view, showing an electric connection between terminals of a battery connecter and terminals of a battery according to the present invention; and

FIGS. 5A and 5B are schematic views, showing terminals of a battery connecter of a preferred embodiment of the present invention.

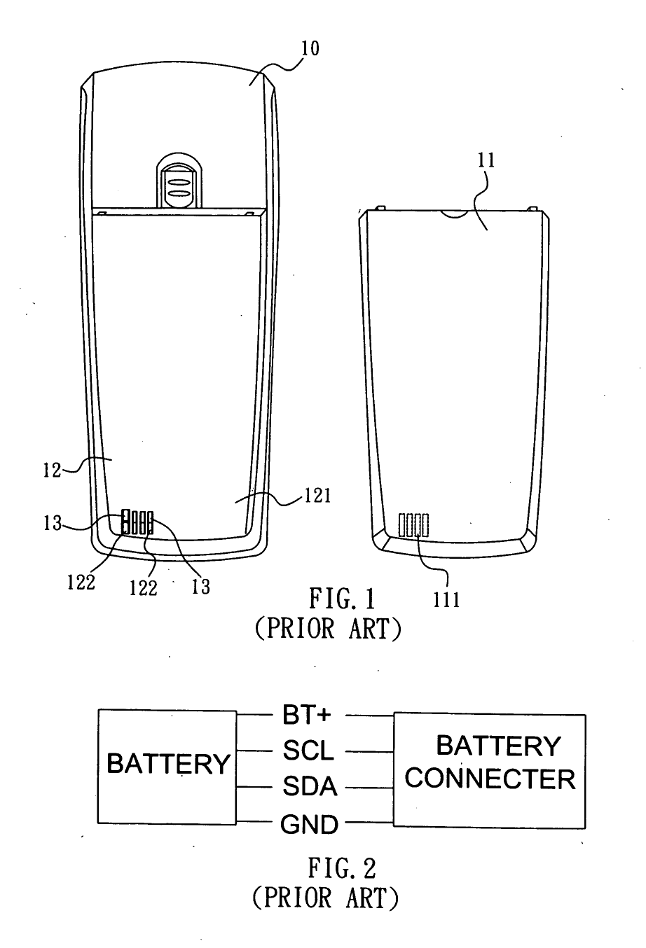

### DETAILED DESCRIPTION OF THE PREFERRED EMBODIMENTS

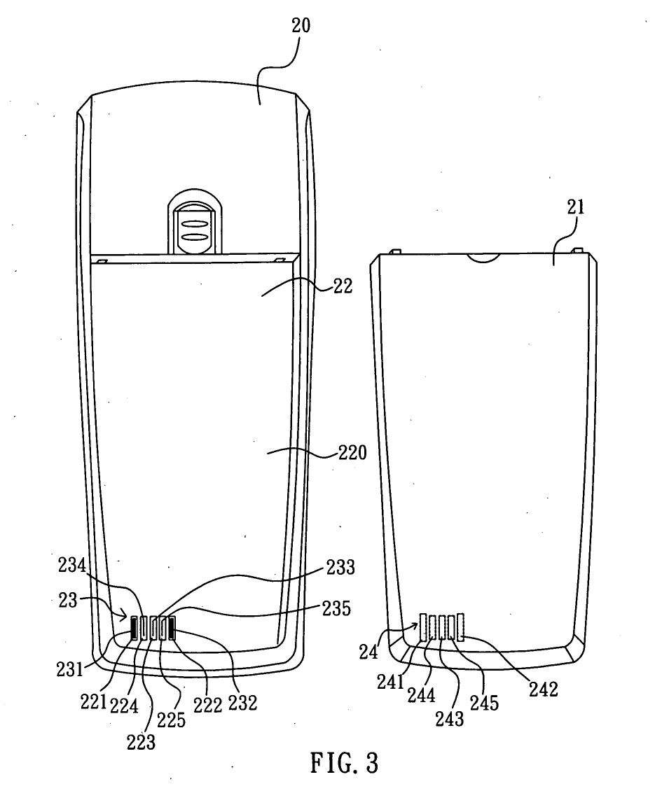

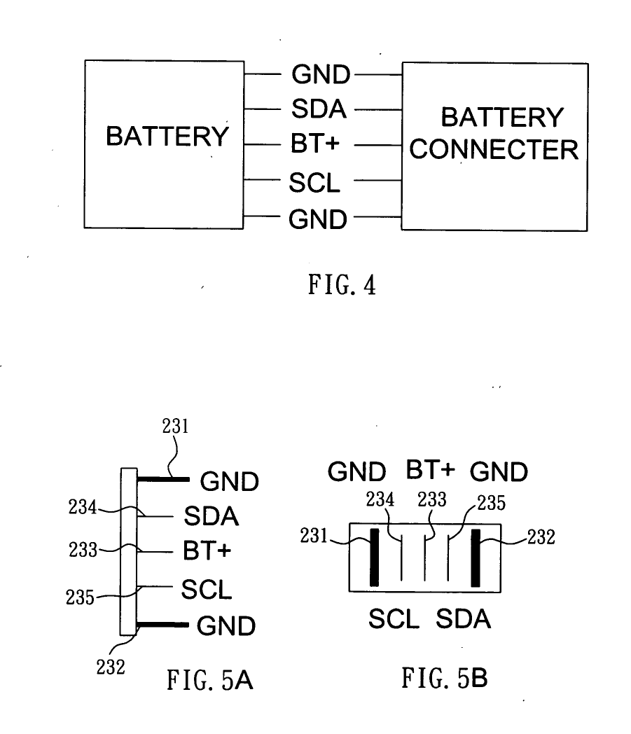

Please refer to FIG. 3. FIG. 3 shows a battery connecter for protecting a circuit system of a preferred embodiment of the present invention. Taking a cellular phone 20 as an example to describe as the following: the cellular phone 20 is provided with combination groove 22 for receiving a battery 21. The combination groove 22 is combined with the battery connecter, the connecter is provided with a plurality of terminals 23. An elastic contact portion at one end of each terminal 23 is projected out from each one of a plurality of groove holes 221, 222, 223, 224 and 225 on a bottom wall 220 of the combination groove 22. The present invention mainly allows two outermost terminals of the terminals 23 of the connecter to be ground terminals (GND) 231 and 232, and the other terminals respectively are a power terminal (BT+) 233 and signal terminals (SCL, SDA) 234 and 235. In the present embodiment, the power terminal (BT+) 233 is disposed at the center as FIGS. 4, 5A and 5B show. Contact portions of the ground terminals 231 and 232 at the sides of the connecter according to the present invention have longer projections than contact portions of the power terminal 233 and the signal terminals 234 and 235 as FIG. 5A shows. Furthermore, the widths of the contact portions of ground terminals 231 and 232 are allowed to be longer than the widths of the power terminal 233 and the signal terminals 234 and 235 as FIG. 5B shows.

Please refer to FIG. 3 again. The battery 21 has terminals 24 corresponding to the terminals 23 of the connecter. Among these, two outermost terminals of the terminals 24 respectively are ground terminals 241 and 242, and other terminals respectively are a power terminal (BT+) 243 and signal terminals 244 and 245. The power terminal (BT+) 243 is disposed at the center as FIG. 4 shows. Furthermore, the contact portions of the ground terminals (GND) 241 and 242 at two sides are allowed to be widest.

The present invention allows the all terminals at two sides of the corresponding terminals of the connecter and the battery to be ground terminals, the ground terminals of the connecter to have contact portions with a longer projection, the both power terminals to be disposed at the center and the power terminals to have the shorter contact portions such that no matter which side the battery is inclined to touch the connecter, it all allows at least one ground terminal of the battery to contact at least one ground terminal of the connecter first. The power terminal of the battery is not allowed to contact thee corresponding terminal of the battery connecter before the ground terminal thereof contacts the corresponding terminal of the battery connecter because the contact portion of the power terminal of the connecter is shorter than the ground terminal thereof and is disposed between two ground terminals thereof. Therefore, the ground terminals of the both battery and battery connecter can be ensured to contact each other first to allow the circuit system to be safer when it is connected with the battery, and rather not to work abnormally or electronic components of the system to be damaged.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A battery connecter for protecting a circuit system, adapted to electrically connect with a battery, said connecter comprising a plurality of terminals respectively projected out from groove holes, said terminals comprising power terminal and ground terminals; terminals at two outermost sides of said terminals being all are ground terminals, contact portions of said ground terminals being provided with longer projections than contact portions of other terminals of said terminals; whereby, ground terminals of a battery and said battery connecter are allowed to get in touch with each other first when said terminals of said connecter are used to electrically connect with said battery and a circuit system is allowed to be safer when said circuit system is electrically connected with said battery.

2. The connecter according to claim 1, wherein said terminals comprises a plurality of signal terminals.

3. The connecter according to claim 2, wherein said power terminal is disposed in the center of said terminals.

4. The connecter according to claim 3, wherein contact portions of said ground terminals have longer widths than contact portions of other terminals of said terminals.

5. A battery, used for being electrically connected with said connecter claimed in claim 1, said battery comprising a plurality of terminals, said terminals comprising a power terminal and ground terminals, terminals at outermost sides of said terminals all are ground terminals.

6. The battery according to claim 5, wherein said terminals comprises a plurality of signal terminals.

7. The battery according to claim 6, wherein said power terminal is disposed at the center of said terminals.

8. The battery according to claim 6, wherein contact portions of said ground terminals have longer widths than contact portions of other terminals of said terminals.
